(19) United States
(12) Patent Application Publication
(10) Pub. No.: US 2026/0113275 A1
(43) Pub. Date: Apr. 23, 2026

(54) Provider Edge (PE) Device Preference in an EVPN All-Active Multihoming Ethernet Segment

(71) Applicant: Juniper Networks, Inc., Sunnyvale, CA (US)

(72) Inventors: Zhaohui Zhang, Westford, MA (US); Soumyodeep Joarder, Bangalore (IN); Vinod Kumar Nagaraj, Cupertino, CA (US); Vikram Nagarajan, Bangalore (IN)

(21) Appl. No.: 19/006,840

(22) Filed: Dec. 31, 2024

(30) Foreign Application Priority Data
Oct. 18, 2024 (IN) 202441079203

(51) Int. Cl. H04L 47/125; H04L 12/46; H04L 45/00; H04L 45/02

(52) U.S. Cl. CPC H04L 47/125; H04L 45/04; H04L 45/54; H04L 12/4641

(57) ABSTRACT

Ethernet VPN supports All-Active multihoming and an ingress Provider Edge (PE) can load balance traffic to all the egress PEs on a multihoming Ethernet Segment (MHES). Methods, devices, and systems to allow an operator to have the ingress PE load-balance to only a set of the PEs on the MHES are described. In the event that all PEs of the set are not usable (e.g., down, not attached to the ES, etc.), the ingress PE can load balance data traffic to one or more PEs on the MHES that are not in the set.

### § 0. RELATED APPLICATION(S)

This application claims benefit to Indian Provisional Application No. 202441079203 (referred to as “the '203 provisional” and incorporated herein by reference), filed on Oct. 18, 2024, titled “PE Preference in EVPN All-Active Multihoming Ethernet Segment”, and listing Zhaohui Zhang, Soumyodeep Joarder, Vinod Kumar Nagaraj, Vikram Nagarajan as the inventors.

### § 1. BACKGROUND OF THE INVENTION

### § 1.1 Field of the Invention

The present application concerns network communications. In particular, the present application concerns controlling the flow of data traffic (e.g., load balancing data traffic, such as due to aliasing) from an ingress provider edge device (PE), such as a PE of an Ethernet Virtual Private Network (EVPN), to one or more egress PEs in a multihomed Ethernet Segment (MHES).

### § 1.2 Background Information

Any information discussed in this section is not to be construed as an admission of prior art.

### § 1.2.1 Ethernet Virtual Private Networks (EVPNs)

Although EVPNs are well-understood by those having ordinary skill in the art, they are introduced here for the reader's convenience.

The document A. Sajassi, Ed., “BGP MPLS-Based Ethernet VPN,” Request for Comments: 7432 (Internet Engineering Task Force, February 2015)(referred to as “RFC 7432” and incorporated herein by reference) describes procedures for BGP MPLS-based Ethernet VPNs (EVPNs). Section 4 of RFC 7432 provides an overview of BGP MPLS-Based EVPN. An EVPN instance comprises Customer Edge devices (CEs) that are connected to Provider Edge devices (PEs) that form the edge of the multi-protocol label switching (MPLS) infrastructure. A CE may be a host, a router, or a switch. The PEs provide virtual Layer 2 bridged connectivity between the CEs. There may be multiple EVPN instances in the provider's network.

The PEs may be connected by an MPLS Label Switched Path (LSP) infrastructure, which provides the benefits of MPLS technology, such as fast reroute, resiliency, etc. The PEs may also be connected by an IP infrastructure, in which case IP/GRE (Generic Routing Encapsulation) tunneling or other IP tunneling can be used between the PEs. RFC 7432 specifies detailed procedures for MPLS LSPs as the tunneling technology. However, those procedures are designed to be extensible to IP tunneling as the Packet Switched Network (PSN) tunneling technology.

In an EVPN, media access control (MAC) learning between PEs occurs not in the data plane, but in the control plane. Control-plane learning offers greater control over the MAC learning process, such as restricting who learns what, and the ability to apply policies.

Furthermore, the control plane chosen for advertising MAC reachability information is multi-protocol (MP) BGP. In EVPN, PEs advertise the MAC addresses learned from the CEs that are connected to them, along with an MPLS label, to other PEs in the control plane using Multiprotocol BGP (MP-BGP).

Control-plane learning enables load balancing of traffic to and from CEs that are multihomed to multiple PEs. This is in addition to load balancing across the MPLS core via multiple LSPs between the same pair of PEs. In other words, control-plane learning allows CEs to connect to multiple active points of attachment. It also improves convergence times in the event of certain network failures. However, data-plane learning is used between PEs and CEs, using the method that is best suited to the CE (e.g., IEEE 802.1x, the Link Layer Discovery Protocol (LLDP), IEEE 802.1aq, Address Resolution Protocol (ARP), management plane, or other protocols).

The policy attributes of EVPN are very similar to those of Internet Protocol Virtual Private Network (IP-VPN). Per RFC 7432, an EVPN instance requires a Route Distinguisher (RD) that is unique per MAC-VRF and one or more globally unique Route Targets (RTs). A CE attaches to a MAC-VRF on a PE, on an Ethernet interface that may be configured for one or more Ethernet tags (e.g., VLAN IDs). Some deployment scenarios guarantee uniqueness of VLAN IDs across EVPN instances (e.g., in which all points of attachment for a given EVPN instance use the same VLAN ID, and no other EVPN instance uses this VLAN ID). RFC 7432 refers to this case as a “Unique VLAN EVPN” and describes simplified procedures to optimize for it.

### § 1.2.1.1 Ethernet Segments (ESs) In EVPNs

RFC 7432 defines Ethernet Segments (ESs). Per the document, A. Sajassi, et al., “Requirements for Ethernet VPN (EVPN),” Request for Comments: 7209 (Internet Engineering Task Force (IETF), May 2014) (referred to as “RFC7209” and incorporated herein by reference), each Ethernet segment needs a unique identifier in an EVPN. Section 5 of RFC 7432 defines how such identifiers are assigned and how they are encoded for use in EVPN signaling. Other sections of RFC 7432 describe the protocol mechanisms that use the identifiers. When a customer site is connected to one or more PEs via a set of Ethernet links, then this set of Ethernet links constitutes an “Ethernet Segment”. For a multihomed site, each Ethernet segment(ES) is identified by a unique non-zero identifier called an Ethernet Segment Identifier (ESI). More specifically, an ESI is encoded as a 10-octet integer in line format with the most significant octet sent first. ESI 0 is reserved and denotes a single-homed (as opposed to a multihomed) site.

In general, an ES should have a non-reserved ESI that is unique network wide (i.e., across all EVPN instances on all the PEs). If the CE(s) constituting an Ethernet segment is (are) managed by the network operator, then ESI uniqueness should be guaranteed. If, however, the CE(s) is (are) not managed, then the operator configures a network-wide unique ESI for that Ethernet segment (to enable auto-discovery of Ethernet segments and Designated Forwarder (DF) election, as described in RFC 7432).

### § 1.2.1.2 Border Gateway Protocol (BGP) EVPN Routes

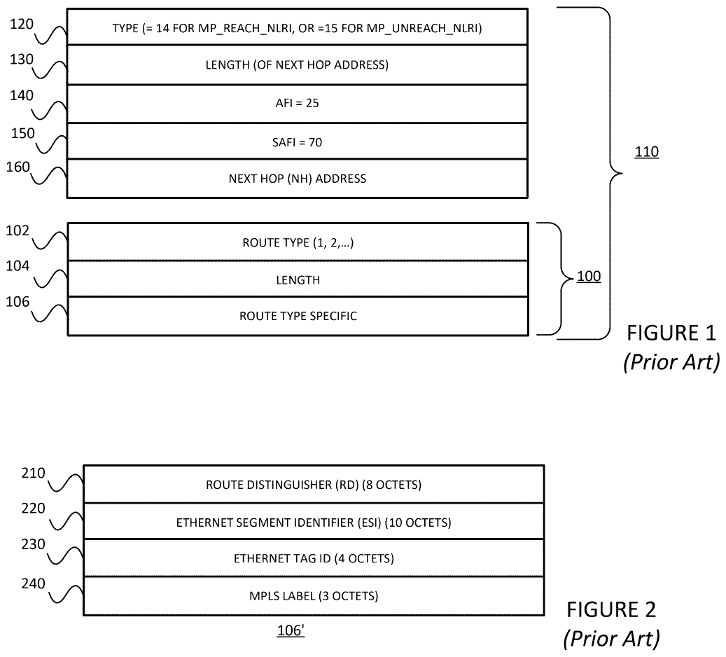

Section 7 of RFC 7432 defines a new BGP Network Layer Reachability Information (NLRI) called the EVPN NLRI. FIG. 1 illustrates the format of the EVPN NLRI 100, which is carried in an MP_REACH_NLRI/MP_UNREACH_NLRI 110. As shown, the Route Type field 102 defines the encoding of the rest of the EVPN NLRI (Route Type specific EVPN NLRI). Four route types are introduced below. The Length field 104 indicates the length in octets of the Route Type specific field 106 of the EVPN NLRI 100. RFC 7432 defines the following Route Types:
i) 1—Ethernet Auto-Discovery (A-D) route;
ii) 2—MAC/IP Advertisement route;
iii) 3—Inclusive Multicast Ethernet Tag route; and
iv) 4—Ethernet Segment route.

The EVPN NLRI 100 is carried in BGP using BGP Multiprotocol Extensions as defined in the document, T. Bates, et al., “Multiprotocol Extensions for BGP-4,” Request for Comments: 4760 (Internet Engineering Task Force (IETF), January 2007) (referred to as “RFC 4760” and incorporated herein by reference) in a multiprotocol reachable NLRI (MP_REACH_NLRI) attribute 110 with a type field 120 carrying 14 for MP_REACH_NLRI or 15 for MP_UNREACH_NLRI, a field 130 carrying the length of the next hop address, field 140 carrying an Address Family Identifier (AFI) of 25 (for L2VPN), a field 150 carrying a Subsequent Address Family Identifier (SAFI) of 70 (for EVPN), and a field 160 carrying the next-hop address within the NLRI (e.g., the IP address of the PE (or VTEP) advertising the EVPN route). The NLRI field in the MP_REACH_NLRI/MP_UNREACH_NLRI attribute 110 contains the EVPN NLRI 100.

EVPN BGP Type 1 advertisements (Ethernet Auto-Discovery advertisements) are used for auto-discovery of Ethernet segments. These advertisements allow devices to learn about the presence of other devices in the EVPN instance. Type 1 advertisements carry information about the Ethernet Segment Identifier (ESI) and the associated Segment Type. This includes details about the attachment circuits and how they relate to the Ethernet segment. Type 1 advertisements are mainly used for multipoint Ethernet segments (such as those connected to multiple devices in a multihomed scenario), and help to identify which devices are part of the same Ethernet segment. Referring to FIG. 2, an Ethernet Auto-discovery (A-D) Route type specific EVPN NLRI 106′ includes an 8 octet Route Distinguisher (RD) field 210, a 10 octet Ethernet Segment Identifier (ESI) field 220, a 4 octet Ethernet Tag ID field 230, and a 3 octet MPLS Label field 240. For the purpose of BGP route key processing, only the ESI and the Ethernet Tag ID are considered to be part of the prefix in the NLRI. The MPLS Label field 240 is to be treated as a route attribute as opposed to being part of the route.

EVPN BGP Type 2 advertisements (Ethernet Segment Route advertisements) are used for distributing MAC (Media Access Control) address information. These advertisements provide details about MAC addresses that are reachable within the EVPN instance. These advertisements include the MAC address, the associated IP address (if applicable), and the Ethernet VPN Route Distinguisher (RD). They also specify the attached devices and the segment they belong to.

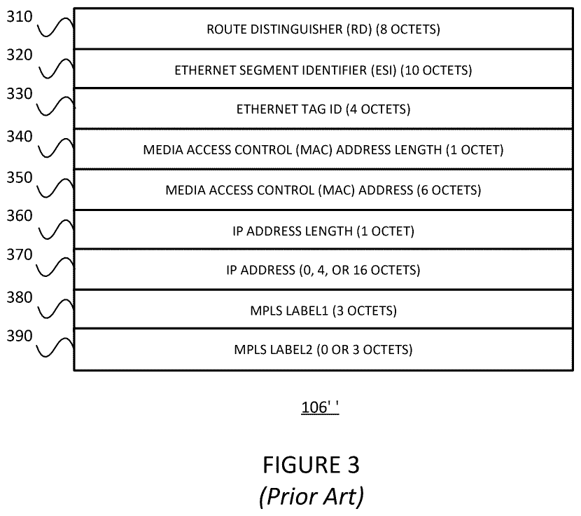

These advertisements facilitate MAC address learning and provide connectivity, and enable traffic to reach the right destination within the EVPN, ensuring that MAC addresses are mapped correctly to the right VPN instance. Referring to FIG. 3, MAC/IP Advertisement route type specific EVPN NLRI 106″ includes an 8 octet route distinguisher (RD) field 310, a 10 octet Ethernet Segment Identifier (ESI) field 320, a 4 octet Ethernet Tag ID field 330, a 1 octet MAC Address Length field 340, a 6 octet MAC Address field 350, a 1 octet IP Address Length field 360, a 0, 4, or 16 octet IP Address field 370, a 3 octet MPLS Label 1 field 380, and a 0 or 3 octet MPLS Label 2 field 390. For the purpose of BGP route key processing, only the Ethernet Tag ID, MAC Address Length, MAC Address, IP Address Length, and IP Address fields are considered to be part of the prefix in the NLRI. The Ethernet Segment Identifier, MPLS Label 1, and MPLS Label 2 fields are to be treated as route attributes as opposed to being part of the “route”. Both the IP and MAC address lengths are in bits.

Section 7.5 of RFC 7432 describes the ESI Label Extended Community, which is a transitive Extended Community. Each ESI Label extended community is encoded as an 8-octet value and has a Type field value of 0x06 and the Sub-Type 0x01, a 1 octet Flags field and a 32 bit ESI label. It may be advertised along with Ethernet Auto-discovery routes, and RFC 7432 notes that it enables split-horizon procedures for multihomed sites. The ESI Label field represents an ES by the advertising PE. The low-order bit of the Flags octet is defined as the “Single-Active” bit. A value of 0 means that the multihomed site is operating in “All-Active” redundancy mode, and a value of 1 means that the multihomed site is operating in “Single-Active”redundancy mode.

Referring back to 210 of FIGS. 2 and 310 of FIG. 3, a route distinguisher (RD) in EVPN is a unique identifier that allows identical IP prefixes in different VPNs to be differentiated. RD helps to maintain the isolation of VPN services (e.g., by helping to ensure that VPN routes are unique within a routing table), while enabling the sharing of the same IP address space among multiple customers or instances. This allows the BGP control plane to maintain separate routing tables for each VPN, ensuring traffic remains isolated. The Route Distinguisher (RD) may be set to the RD of the MAC-VRF that is advertising the NLRI. An RD is assigned for a given MAC-VRF on a PE. The RD is unique across all MAC-VRFs on a PE. The value field comprises an IP address of the PE (typically, the loopback address) and a (appended or prepended) number unique to the PE.

### § 1.2.1.3 Multihomed Ethernet Segment Auto-Discovery

PEs connected to the same Ethernet segment can automatically discover each other with minimal to no configuration through the exchange of the Ethernet Segment Route. In the Ethernet Segment Route, the Route Distinguisher (RD) is a Type 1 RD, and the value field comprises an IP address of the PE (typically, the loopback address) followed by a number unique to the PE. The Ethernet Segment Identifier (ESI) is set to the 10-octet value described in section 5 of RFC 7432. The BGP advertisement that advertises the Ethernet Segment route also carries an ES-Import Route Target, as defined in section 7.6 of RFC 7432. The Ethernet Segment routes are filtered such that the Ethernet Segment route is imported only by the PEs that are multihomed to the same Ethernet segment. To that end, each PE that is connected to a particular Ethernet segment constructs an import filtering rule to import a route that carries the ES-Import Route Target, constructed from the ESI.

EVPN defines a mechanism to efficiently and quickly signal, to remote PE nodes, the need to update their forwarding tables upon the occurrence of a failure in connectivity to an Ethernet segment. This is done by having each PE advertise a set of one or more Ethernet A-D per ES routes for each locally attached Ethernet segment. A PE may need to advertise more than one Ethernet A-D per ES route for a given ES because the ES may be in a plurality of EVIs, and the RTs for all of these EVIs might not fit into a single route. Advertising a set of Ethernet A-D per ES routes for the ES allows each route to contain a subset of the complete set of RTs. Each Ethernet A-D per ES route is differentiated from the other routes in the set by a different Route Distinguisher (RD). Upon a failure in connectivity to the attached segment, the PE withdraws the corresponding set of Ethernet A-D per ES routes. This, in turn, triggers all PEs that receive the withdrawal to update their next-hop adjacencies for all MAC addresses associated with the Ethernet segment in question. If no other PE had advertised an Ethernet A-D route for the same segment, then the PE that received the withdrawal simply invalidates the MAC entries for that segment. Otherwise, the PE updates its next-hop adjacencies accordingly.

### § 1.2.1.4 Aliasing and Backup Path

EVPN aliasing allows multiple Ethernet segments to be represented by a single Virtual Ethernet Interface, simplifying the management of networks. Thus, instead of needing separate control plane instances for each Ethernet segment, aliasing allows multiple segments to be represented as one. This reduces overhead, simplifies configuration and improves scalability. Aliasing can also facilitate load balancing across multiple paths, improving performance and redundancy.

More specifically, if a CE is multihomed to multiple PE nodes, using a Link Aggregation Group (LAG) with All-Active redundancy, it is possible that only a single PE learns a set of the MAC addresses associated with traffic transmitted by the CE. This leads to a situation where remote PE nodes receive MAC/IP Advertisement routes for these addresses from a single PE, even though multiple PEs are connected to the multihomed segment. As a result, the remote PEs are not able to effectively load balance (e.g., ingress) traffic among the PE nodes connected to the multihomed Ethernet segment. This could occur, for example, when the PEs perform data-plane learning on the access, and the load-balancing function on the CE hashes traffic from a given source MAC address to a single PE. This could also occur if the PEs rely on control-plane learning on the access (e.g., using ARP), since ARP traffic will be hashed to a single link in the LAG.

To address this issue, EVPN introduces the concept of “aliasing,” which is the ability of a PE to signal that it has reachability to an EVPN instance on a given ES even when it has learned no MAC addresses from that EVI/ES. The Ethernet A-D per EVI route is used for this purpose. A remote PE that receives a MAC/IP Advertisement route with a non-reserved ESI should consider the advertised MAC address to be reachable via all PEs that have advertised reachability to that MAC address's EVI/ES via the combination of (1) an Ethernet A-D per EVI route for that EVI/ES (and Ethernet tag, if applicable) and (2) Ethernet A-D per ES routes for that ES with the “Single-Active”bit in the flags of the ESI Label extended community set to 0. Since the Ethernet A-D per EVI route may be received by a remote PE before it receives the set of Ethernet A-D per ES routes, in order to handle corner cases and race conditions, the Ethernet A-D per EVI route is not to be used for traffic forwarding by a remote PE until it also receives the associated set of Ethernet A-D per ES routes.

The backup path is a closely related function, but it is used in Single-Active redundancy mode. In this case, a PE also advertises that it has reachability to a given EVI/ES using the same combination of Ethernet A-D per EVI route and Ethernet A-D per ES route as discussed above, but with the “Single-Active” bit in the flags of the ESI Label extended community set to 1. A remote PE that receives a MAC/IP Advertisement route with a non-reserved ESI should consider the advertised MAC address to be reachable via any PE that has advertised this combination of Ethernet A-D routes, and it should install a backup path for that MAC address.

Section 8.4.1 of RFC 7432 describes how to construct an Ethernet A-D per EVPN Instance Route. Recall that the Ethernet A-D per EVPN instance (EVI) route is used for aliasing. The Route Distinguisher (RD) is set per section 7.9 of RFC 7432. The Ethernet Segment Identifier (ESI) is a 10-octet entity. The Ethernet A-D route is not needed when the Segment Identifier is set to 0. The Ethernet Tag ID identifies an Ethernet tag on the Ethernet segment. This value may be a 12-bit VLAN ID (in which case the low-order 12 bits are set to the VLAN ID and the high-order 20 bits are set to 0), or another Ethernet tag used by the EVPN.

Note that the above allows the Ethernet A-D route to be advertised with one of the following granularities: (1) one Ethernet A-D route per <ESI, Ethernet Tag ID>tuple per MAC-VRF (applicable when the PE uses MPLS-based disposition with VID translation or when the PE uses MAC-based disposition with VID translation); or (2) one Ethernet A-D route for each <ESI> per MAC-VRF (where the Ethernet Tag ID is set to 0) (applicable when the PE uses MAC-based disposition or MPLS-based disposition without VID translation).

The MPLS label may be used for load balancing of unicast packets (e.g., per section 14 of RFC 7432). The Next Hop field of the MP_REACH_NLRI attribute of the route is set to the IPv4 or IPv6 address of the advertising PE. The Ethernet A-D route carries one or more Route Target (RT) attributes.

### § 1.3 Unmet Needs

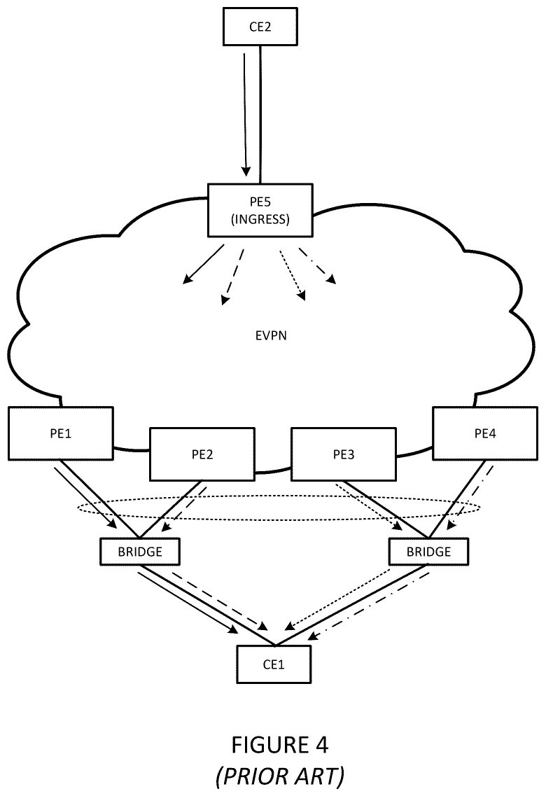

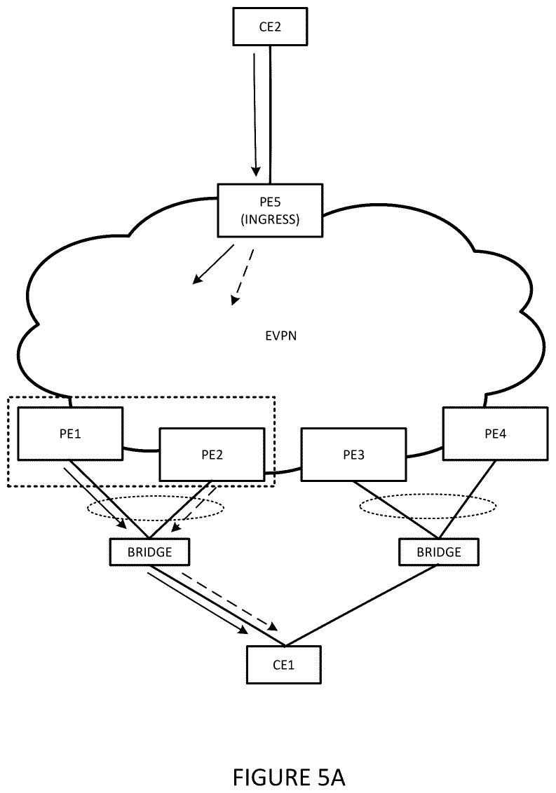

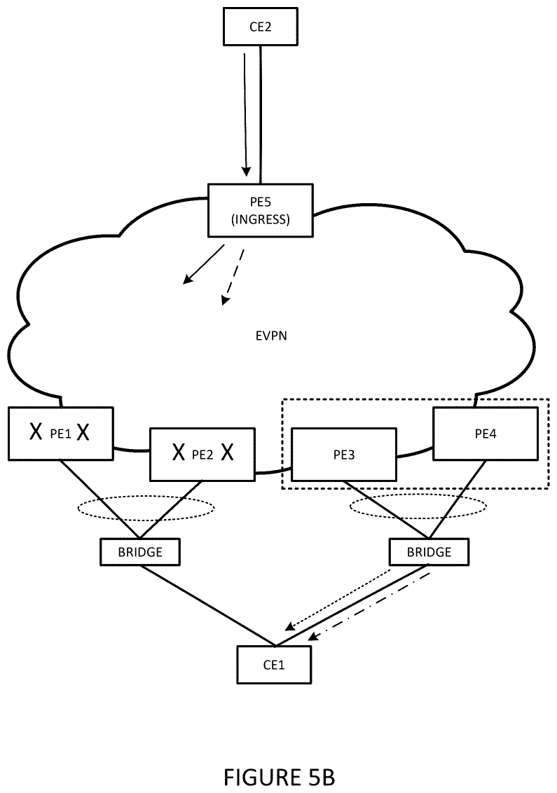

Consider the RFC 7432 compliant EVPN illustrated in FIG. 4. CE2 is multihomed to four PEs (PE1, PE2, PE3, PE4) via two switches (SW1 and SW2). Traffic from CE1 (e.g., destined for CE2) can be load-balanced to all the four egress PEs (e.g., per RFC 7432), as indicated by the solid, dashed, dotted, and dot-dash lines. However, the present inventors recognize that a network operator might wish to choose to designate a subset of the four egress PEs (say PE1 and PE2 in this example) as a “preferred” PEs such that traffic is normally only sent via the preferred set of PEs (e.g., PE1 and PE2) (as illustrated in FIG. 5A), and traffic is only sent via PE(s) (e.g., PE3 and/or PE4) not in the preferred set when all of the PEs in the preferred set (e.g., both PE1 and PE2) are unusable (as illustrated in FIG. 5B). RFC 7432 has no specific mechanism or procedure to allow this type of operation. Therefore, it would be useful to allow an operator to designate a sub-set of one or more preferred PE(s) for a given MHES such that in ingress PE will load balance traffic to only those PE(s) belonging to the set (assuming that at least one PE belonging to the set is usable. (Recall, e.g., FIG. 5A.) It would also be useful to support situations in which all of the PEs belonging to the set are not usable. (Recall, e.g., FIG. 5B.)

### § 2. SUMMARY OF THE INVENTION

An example computer-implemented method, consistent with the present description, for controlling aliasing behavior by an ingress provider edge (PE) device (for use in an Ethernet Virtual Private Network (EVPN) having a plurality of PE devices on a multihoming Ethernet Segment (MHES), on the EVPN), includes: (a) configuring, on each of the plurality of PEs on the MHES, a preference value for the MHES, such that a set of one or more of the plurality of PEs each have a preference value higher (or lower) than the preference value of any of the plurality of PEs on the MHES not belonging to the set; and (b) advertising, by each of the plurality of PEs on the MHES, its preference value to the ingress PE.

In some example implementations, the advertisement is an EVPN Ethernet Auto Discover per ES route. In at least some such example implementations, the preference value is encoded in the Designated Forwarder (DF) Election Extended Community.

The example computer-implemented method may further include: (c) receiving, by the ingress PE, the advertised preference values sourced from each of the plurality of PEs on the MHES; and (d) responsive to receiving the advertised preference values from each of the plurality of PEs on the MHES, generating forwarding table information including an aliasing next hop (NH) such the ingress PE will (A) load balance traffic for the MHES across any usable PEs within the set, or (B) load balance traffic for the MHES across at least one PE not within the set responsive to all of the PEs within the set being unusable. In some such implementations, the PEs within the set are primary members of the aliasing NH, and PEs not within the set are backup members of the aliasing NH. In some such implementations, the PEs not within the set are Fast ReRoute (FRR) NHs. The example computer-implemented method may further include: (e) receiving, by the ingress PE, updated advertised preference values sourced from each of a plurality of PEs on the MHES; and (f) responsive to receiving the updated advertised preference values from each of the plurality of PEs on the MHES, rerunning an aliasing procedure.

In at least some example implementations, the MHES is associated with a cluster ESI including (1) an ESI including the PEs within the set, and (2) at least one ESI including PEs not within the set.

In at least some example implementations, the MHES is associated with both (1) a first ESI including information indicating that the first ESI is of a type cluster ESI and further information identifying the first ESI, and (2) a second ESI including the information indicating that the second ESI is of a type cluster ESI and further information identifying the second ESI.

An example non-transitory computer readable storage medium stores processor executable instructions which, when executed by at least one processor, cause the at least one processor to perform any of the example methods described.

An example system is provided for use in an Ethernet Virtual Private Network (EVPN) having a plurality of provider edge devices (PEs) on a multihoming Ethernet Segment (MHES) and an ingress PE on the EVPN. The example system includes the plurality of PEs, each of the plurality of PEs comprising: (a) at least one processor; and (b) at least one computer readable storage system storing processor executable instructions which, when executed by the at least one processor, cause the at least one processor to (1) configure on the PE on the MHES, a preference value for the MHES, such that a set of one or more of the plurality of PEs each have a preference value higher (or lower) than the preference value of any of the plurality of PEs on the MHES not belonging to the set, and (2) advertise, by each the PE on the MHES, its preference value to the ingress PE.

The example system may further include the ingress PE, the ingress PE comprising: (a) at least one processor; and (b) at least one computer readable storage system storing processor executable instructions which, when executed by the at least one processor of the ingress PE, cause the at least one processor of the ingress PE to (1) receive the advertised preference values sourced from each of the plurality of PEs on the MHES, and (2) responsive to receiving the advertised preference values from each of the plurality of PEs on the MHES, generate forwarding table information including an aliasing next hop (NH) such the ingress PE will (A) load balance traffic for the MHES across any usable PEs within the set, or (B) load balance traffic for the MHES across at least one PE not within the set responsive to all of the PEs within the set being unusable.

In at least some example systems, the PEs within the set are primary members of the aliasing NH, and PEs not within the set are backup members of the aliasing NH. In at least some example systems, the PEs not within the set are Fast ReRoute (FRR) NHs.

In at least some example systems, the MHES is associated with a cluster ESI including (1) an ESI including the PEs within the set, and (2) at least one ESI including PEs not within the set.

In at least some example systems, the MHES is associated with both (1) a first ESI including information indicating that the first ESI is of a type cluster ESI and further information identifying the first ESI, and (2) a second ESI including the information indicating that the second ESI is of a type cluster ESI and further information identifying the second ESI.

### § 3. BRIEF DESCRIPTION OF THE DRAWINGS

### FIG. 1 illustrates the Format of the EVPN NLRI Carried in an MR_REACH_NLRI attribute.

FIG. 2 illustrates the format of an Ethernet Auto-discovery (A-D) Route type specific EVPN NLRI.

FIG. 3 illustrates the format of a MAC/IP Advertisement route type specific EVPN NLRI.

FIG. 4 illustrates an example EVPN network.

FIGS. 5A and 5B illustrate desired operations in the example EVPN network of FIG. 4.

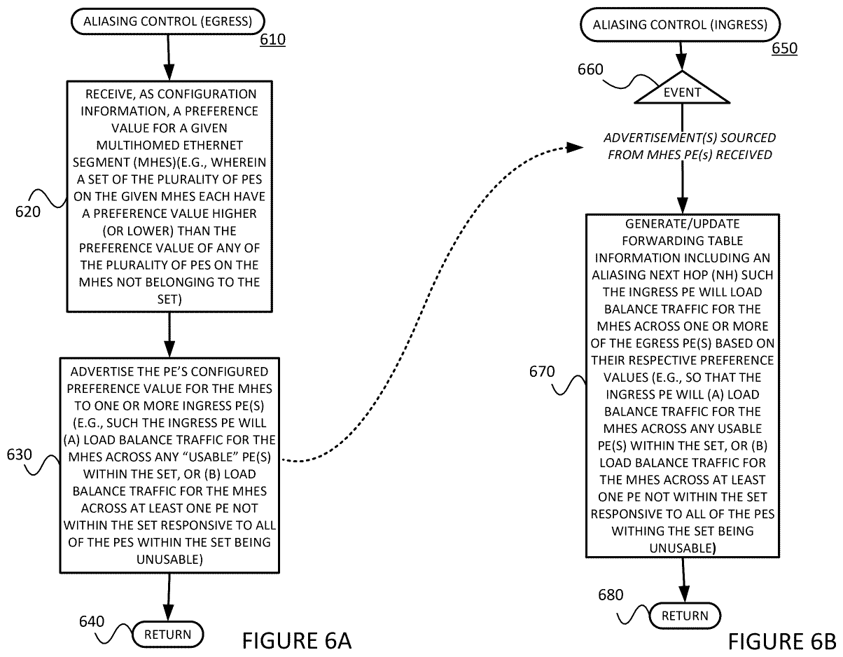

FIGS. 6A and 6B are flow diagrams of methods for controlling the flow of data traffic (e.g., load balancing data traffic, such as due to aliasing) from an ingress PE to one or more egress PEs in a multihomed Ethernet Segment (MHES), in a manner consistent with the present application.

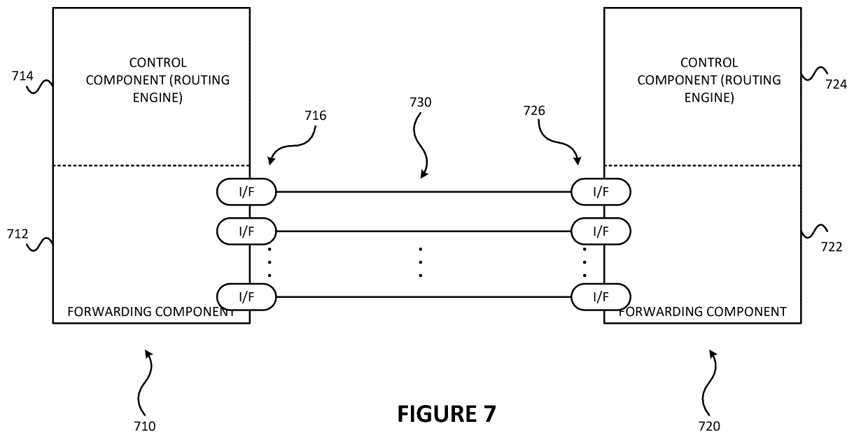

FIG. 7 illustrates two data forwarding devices, which may be used as nodes, coupled via communications links, in a communications network.

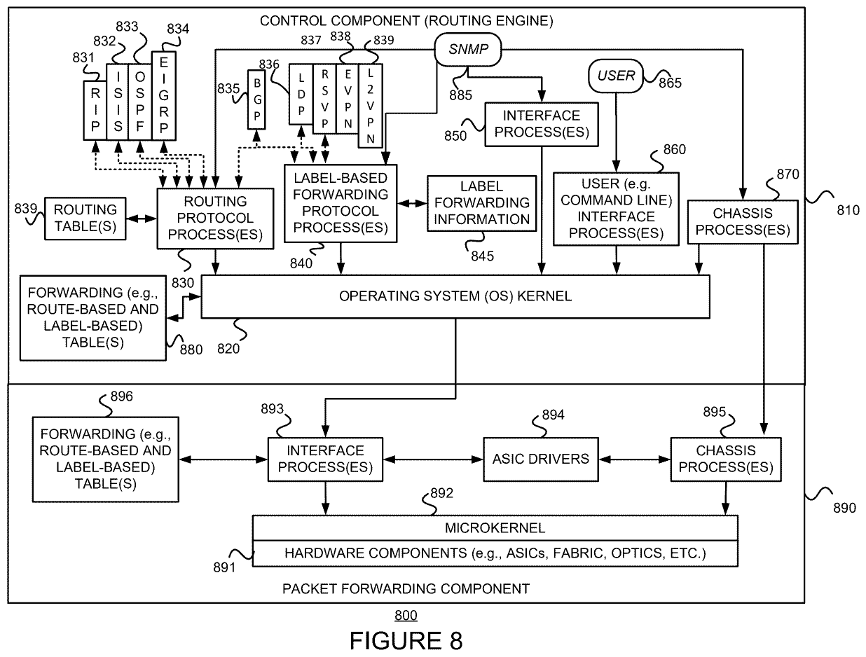

FIG. 8 is a block diagram of a router which may be used a communications network, in which example implementations consistent with the present application can be implemented.

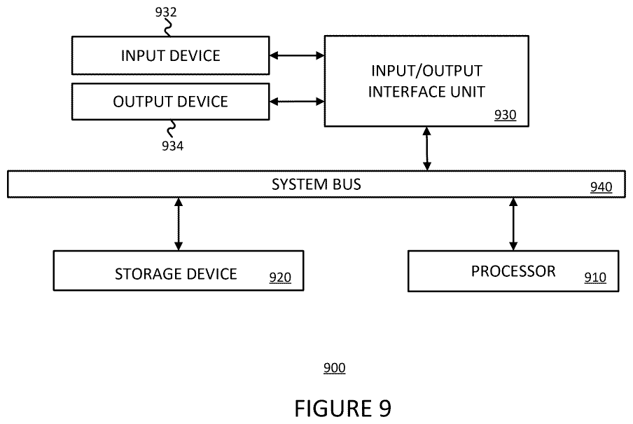

FIG. 9 is a block diagram of an exemplary machine that may perform one or more of the processes described, and/or store information used and/or generated by such processes.

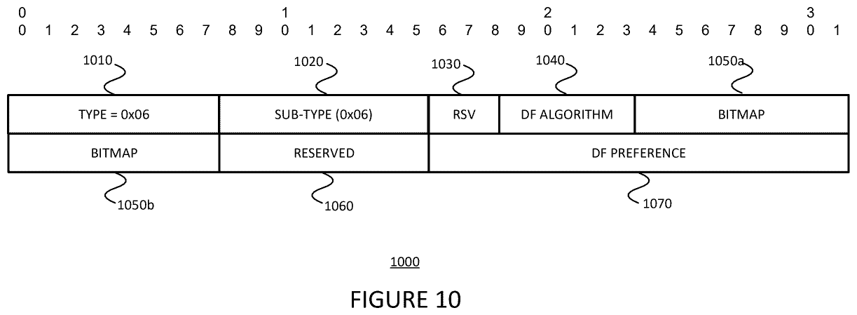

FIG. 10 is an example data structure for carrying a PE preference value for a given MHES in a manner consistent with some example implementations of the present application.

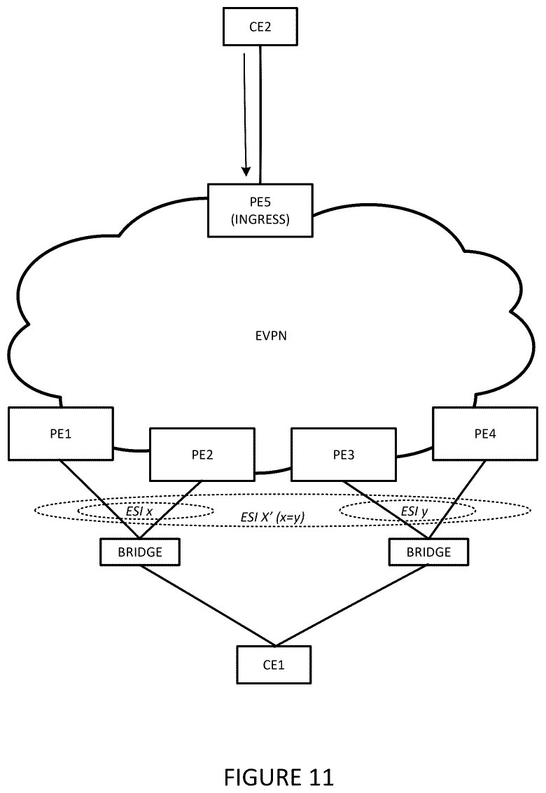

FIG. 11 illustrates the concepts of a cluster ESI including two or more ESIs.

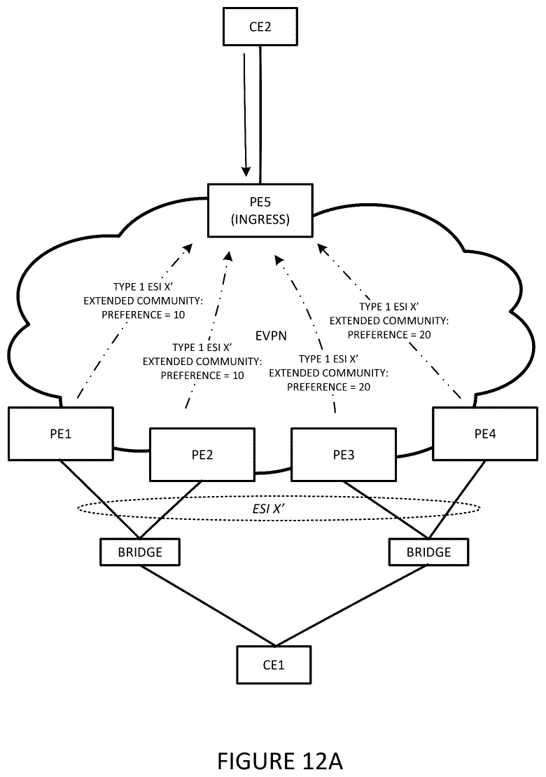

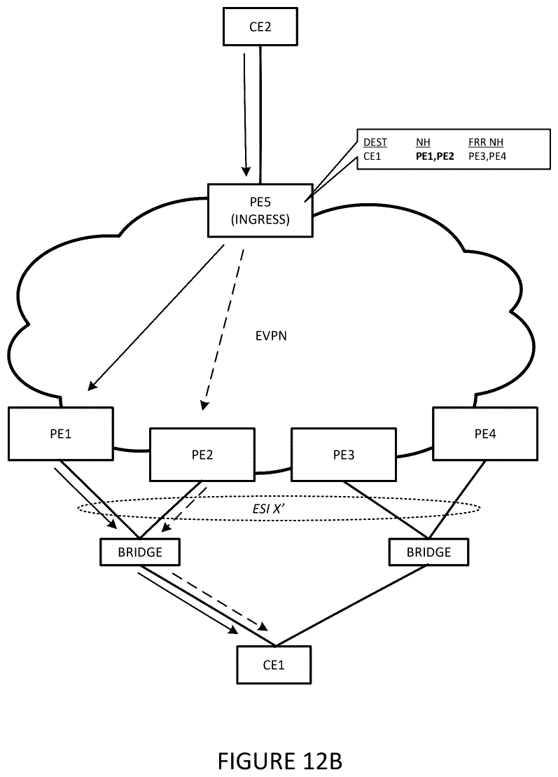

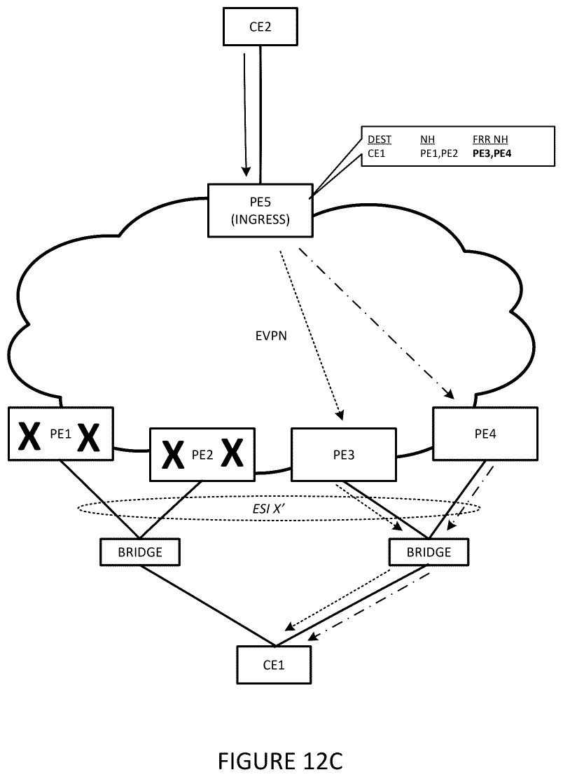

FIGS. 12A-12C illustrate an example of operations of a first example method consistent with the present description.

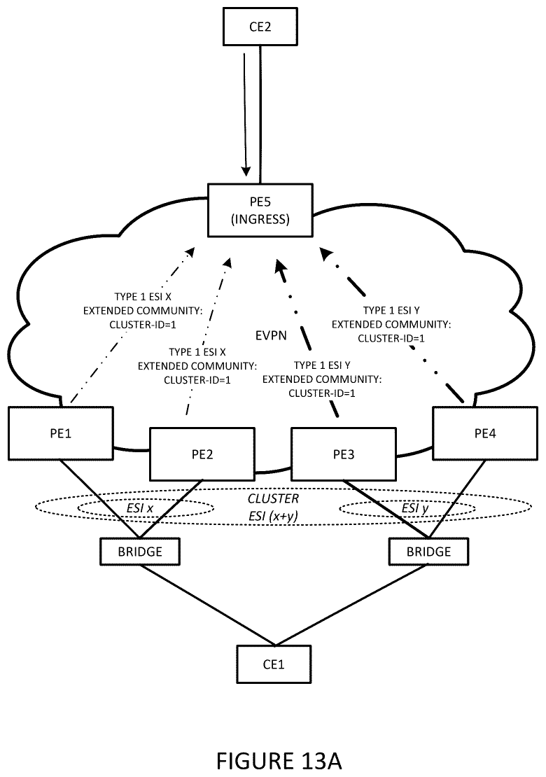

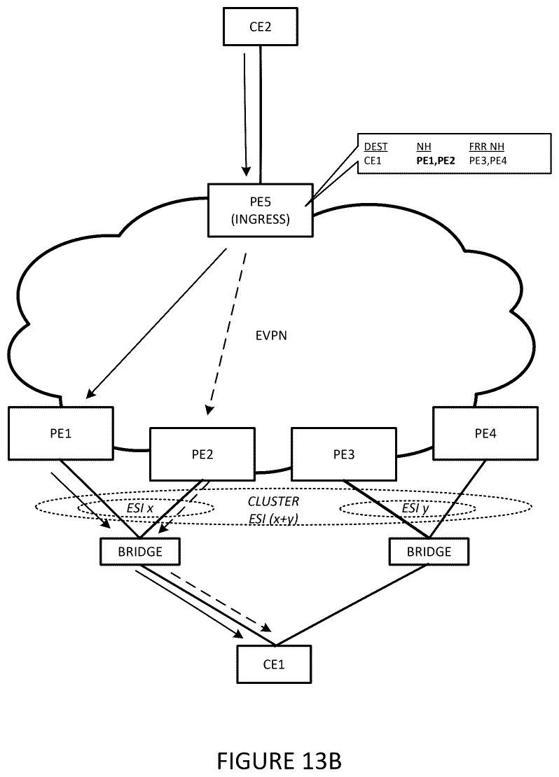

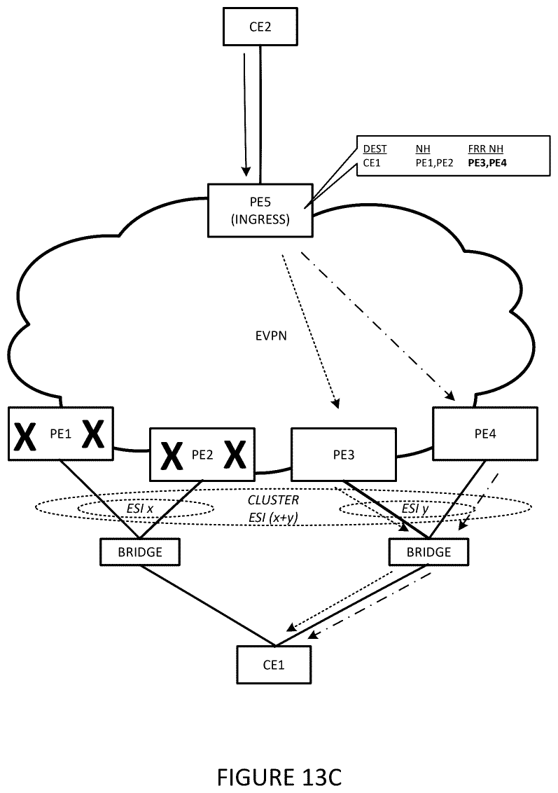

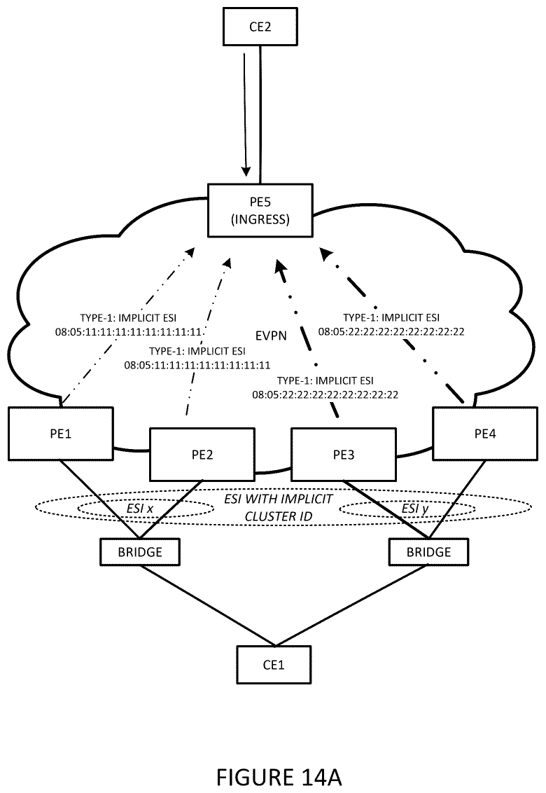

FIGS. 13A-13C illustrate an example of operations of a first alternative method consistent with the present description.

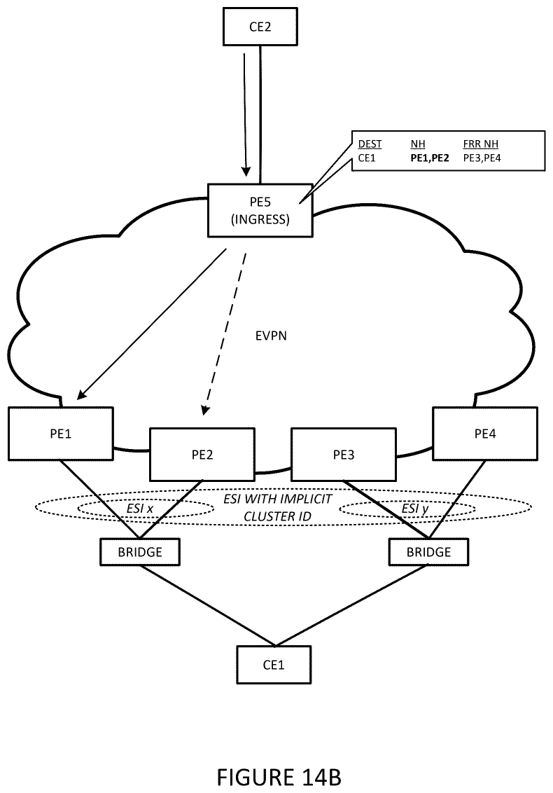

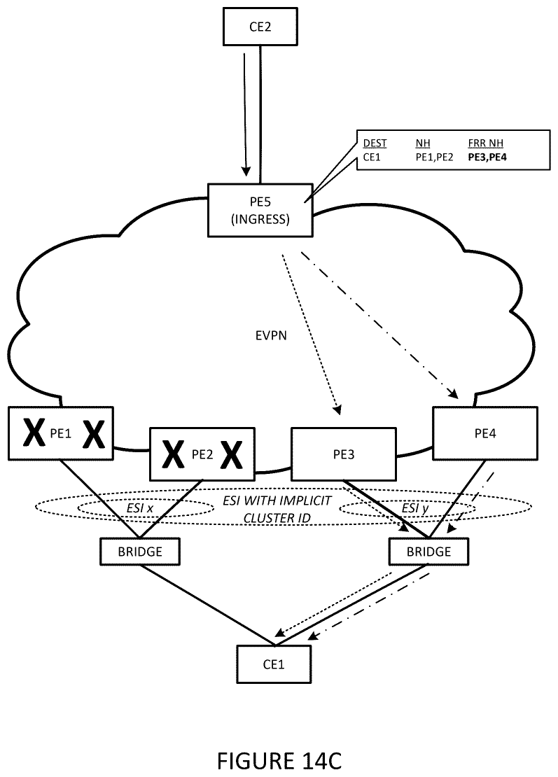

FIGS. 14A-14C illustrate an example of operations of a second alternative method consistent with the present description.

### § 4. DETAILED DESCRIPTION

The present disclosure may involve novel methods, apparatus, message formats, and/or data structures to enable aliasing over a preferred set of egress PEs on an ES in an EVPN (if any of those preferred PEs is usable. The following description is presented to enable one skilled in the art to make and use the described embodiments, and is provided in the context of particular applications and their requirements. Thus, the following description of example embodiments provides illustration and description, but is not intended to be exhaustive or to limit the present disclosure to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present description unless explicitly described as such. Also, as used herein, the article “a” is intended to include one or more items. Where only one item is intended, the term “one” or similar language is used. Thus, the present disclosure is not intended to be limited to the embodiments shown and the inventors regard their invention as any patentable subject matter described.

### § 4.1 Definitions and Acronyms

Broadcast Domain: In a bridged network, the broadcast domain corresponds to a Virtual LAN (VLAN), where a VLAN is typically represented by a single VLAN ID (VID) but can be represented by several VIDs where Shared VLAN Learning (SVL) is used per [802.1Q].

Bridge Table: An instantiation of a broadcast domain on a MAC-VRF.

CE: Customer Edge device, e.g., a host, router, or switch.

EVI: An EVPN instance spanning the Provider Edge (PE) devices participating in that EVPN.

Ethernet Segment (ES): When a customer site (device or network) is connected to one or more PEs via a set of Ethernet links, then that set of links is referred to as an ‘Ethernet segment’.

Ethernet Segment Identifier (ESI): A unique non-zero identifier that identifies an Ethernet segment is called an ‘Ethernet Segment Identifier’.

Ethernet Tag: An Ethernet tag identifies a particular broadcast domain, e.g., a VLAN. An EVPN instance consists of one or more broadcast domains.

LACP: Link Aggregation Control Protocol.

MAC-VRF: A Virtual Routing and Forwarding table for Media Access Control (MAC) addresses on a PE.

MP2MP: Multipoint to Multipoint.

MP2P: Multipoint to Point.

P2MP: Point to Multipoint.

P2P: Point to Point.

PE: Provider Edge device.

“Preferred” means that a device (e.g., an ingress PE) intending to forward data will forward that data with preference to a set of one or more preferred device(s) (e.g., preferred egress PE(s)).

Single-Active Redundancy Mode: When only a single PE, among all the PEs attached to an Ethernet segment, is allowed to forward traffic to and/or from that Ethernet segment for a given VLAN, then the Ethernet segment is defined to be operating in Single-Active redundancy mode.

All-Active Redundancy Mode: When all PEs attached to an Ethernet segment are allowed to forward known unicast traffic to and/or from that Ethernet segment for a given VLAN, then the Ethernet segment is defined to be operating in All-Active redundancy mode.

“Usable” or “Unusable”: Whether a PE (e.g., an egress PE on a MHES) is “usable” (for forwarding) means that the PE is UP and attached to the ES, and that the device intending to forward data (e.g., an ingress PE) to the PE has a route and resolvable next hop. Usability (for forwarding) is generally determined from the perspective of the device intending to forward data to/via the PE. Note that if a route is implicitly or explicitly withdrawn, the PE associated with the withdrawn route is not usable. Whether a PE (e.g., an egress PE on a MHES) is “unusable” (for forwarding) means that a PE is either DOWN, not attached to the ES, the device intending to forward data (e.g., an ingress PE) to the PE does not have a route, and/or does not have a resolvable next hop. Whether a PE is “usable” or “unusable” is generally determined from the perspective of the device intending to forward data (e.g., an ingress PE) to/via the PE. For example, whether or not an egress PE is “usable” for an MHES can be determined by the existence of a valid Ethernet A-D per ES route advertised by the egress PE for the MHES. The route may be explicitly withdrawn (e.g., when the egress PE's attachment circuit (AC) to the MHES goes down), or considered implicitly withdrawn (e.g., when the BGP session to the PE goes down), or the next hop of the route becomes unreachable, or there are some other situations that change the validity.

### § 4.2 Example Method(s)

FIGS. 6A and 6B are flow diagrams of example methods, to be performed at egress PEs on a multihoming Ethernet Segment (MHES) and at least one ingress PE, respectively, to enable controlling the flow of data traffic (e.g., load balancing data traffic, such as due to aliasing) from the ingress PE to one or more egress PEs on the MHES, in a manner consistent with the present application. If one or more of the preferred egress PE(s) is/are “usable”, the ingress PE will send (e.g., load-balanced or aliased) data traffic over the preferred egress PE(s). If, however, none of the preferred egress PE(s) is “usable” (that is, all of the preferred egress PEs are “unusable”), then the ingress PE will send (e.g., load-balanced or aliased) data traffic over one or more non-preferred PE(s). Referring first to the example method 610 of FIG. 6A, each of the plurality of PEs on the MHES is configured with a preference value for the MHES. (Block 620) In order to achieve desired operations such as those illustrated in FIGS. 5A and 5B, the preference values of the egress PEs on the MHES are collectively configured such that a set of one or more of the plurality of egress PEs each have a preference value higher (or lower, depending on design) than the preference value of any of the plurality of PEs on the MHES not belonging to the set. Each of the plurality of egress PEs on the MHES then advertises its preference value to the ingress PE. (Block 630) Referring next to the example method 650 of FIG. 6B, responsive to receiving, by the ingress PE, the advertised preference values sourced from each of the plurality of PEs on the MHES (Event 660), the example method 660 generates forwarding table information (or updates existing forwarding table information) including an aliasing next hop (NH) such the ingress PE will (A) load balance traffic for the MHES across any preferred (e.g., based on highest or lowest preference values) PE(s) that are usable, or (B) load balance traffic for the MHES across at least one non-preferred PE responsive to all of the preferred PE(s) (e.g., all PEs within the set) being unusable. (Block 670)

In summary, each egress PE on the MHES has a preference value, and the ingress PE picks the usable PE(s) with the best preference. There may be one or more usable PE(s) configured with the best preference, and load-balancing (e.g., aliasing) occurs when there is more than one usable preferred PE.

Referring back to block 670 of FIG. 6B, the PEs within the set are primary members of the aliasing next hop (NH), and at least one PE(s) not within the set is/are backup members of the aliasing NH. For example, the PEs not within the set are Fast ReRoute (FRR) NHs.

Still referring to block 670 of FIG. 6B, when the set of PE(s) with the best preference value changes, the ingress PE will update its forwarding information accordingly. For example, referring to event 660 of FIG. 6B, the ingress PE may receive updated advertised preference values sourced from each of the plurality of PEs on the MHES (e.g., due to an Ethernet Auto-Discovery per ES route being received, withdrawn, becoming unusable, becoming usable, etc.). Responsive to receiving the updated advertised preference values from any of the plurality of PEs on the MHES and/or responsive to receiving an indication that a usable PE has become unusable, or an unusable PE has become usable, the ingress PE may rerun an aliasing procedure, which may result in updated forwarding information. (Block 670)

Referring back to block 630 of FIG. 6A, in some example implementations, the advertisement is an EVPN Ethernet AutoDiscover per ES route. For example, the preference value may be encoded in the Designated Forwarder (DF) Election Extended Community.

Referring back to FIGS. 5A and 5B, an operator may choose to designate the PE1,PE2 pair as the preferred PEs so that traffic for CE1 is normally only sent to PE1,PE2. It is only when both PE1 and PE2 are unusable that the traffic for CE1 is sent to PE3,PE4.

Referring back to FIGS. 6A and 6B, this desired outcome can be achieved if the MHES PEs (PE1-PE4) each signal a preference value for an ES, and the ingress PE(s) (PE5) only sends traffic to the one advertising the highest (or lowest, depending on selection algorithm) preference value. If there are multiple MHES PEs advertising the same highest (or lowest) preference value, then load-balancing across those PEs is used.

The assignment of preference values is important because the less preferred PEs will not be used until all the preferred PEs become unusable, whether the Weighted Multi-Path Procedures for EVPN Multihoming (See, e.g., the document, N. Malhotra, Ed., “Weighted Multi-Path Procedures for EVPN Multi-Homing,” draft-ietf-bess-evpn-unequal-lb-21 (Internet Engineering Task Force, Dec. 7, 2023) (incorporated herein by reference)) is used or not.

In the document, J. Rabadan, Ed., “Preference-based EVPN DF Election,” draft-ietf-bess-evpn-pref-df-13 (Internet Engineering Task Force, Oct. 9, 2023) (incorporated herein by reference), the MHES PEs attach a Designated Forwarder (DF) Election Extended Community to the EVPN Ethernet Segment (Type 4) routes, in which a DF Preference value is encoded. Although the Designated Forwarder (DF) Election Extended Community was intended to aid DF election, the same extended community can be attached to the EVPN Ethernet Auto-Discover (Type 1) per ES route to signal the preference that an ingress PE is to use when choosing the egress PEs (e.g., choosing a primary set of egress PEs and a backup set of egress PEs).

### § 4.3 Example Apparatus

Nodes in a data communications network may be data forwarding devices, such as routers for example. FIG. 7 illustrates two data forwarding devices 710 and 720 coupled via communications links 730. The links may be physical links or “wireless” links. The data forwarding devices 710,720 may be routers for example. If the data forwarding devices 710,720 are example routers, each may include a control component (e.g., a routing engine) 714,724 and a forwarding component 712,722. Each data forwarding device 710,720 includes one or more interfaces 716,726 that terminate one or more communications links 730.

FIG. 8 illustrates an example router. As discussed above, some example routers 800 include a control component (e.g., routing engine) 810 and a packet forwarding component (e.g., a packet forwarding engine) 890.

The control component 810 may include an operating system (OS) kernel 820, routing protocol process(es) 830, label-based forwarding protocol process(es) 840, interface process(es) 850, user interface (e.g., command line interface (CLI)) process(es) 860, and chassis process(es) 870, and may store routing table(s) 839, label forwarding information 845, and forwarding (e.g., route-based and/or label-based) table(s) 880. As shown, the routing protocol process(es) 830 may support routing protocols such as the routing information protocol (“RIP”) 831, the intermediate system-to-intermediate system protocol (“IS-IS”) 832, the open shortest path first protocol (“OSPF”) 833, the enhanced interior gateway routing protocol (“EIGRP”) 834 and the border gateway protocol (“BGP”) 835, and the label-based forwarding protocol process(es) 840 may support protocols such as BGP 835, the label distribution protocol (“LDP”) 836, the resource reservation protocol (“RSVP”) 837, EVPN 838 and L2VPN 839, segment routing (SR) (not shown), multi-protocol label switching (MPLS) (not shown), etc. One or more components (not shown) may permit a user 865 to interact with the user interface process(es) 860. Similarly, one or more components (not shown) may permit an outside device to interact with one or more of the router protocol process(es) 830, the label-based forwarding protocol process(es) 840, the interface process(es) 850, and/or the chassis process(es) 870, via SNMP 885, and such processes may send information to an outside device via SNMP 885.

The packet forwarding component 890 may include a microkernel 892 over hardware components (e.g., ASICs, switch fabric, optics, etc.) 891, interface process(es) 893, ASIC drivers 894, chassis process(es) 895 and forwarding (e.g., route-based and/or label-based) table(s) 896.

In the example router 800 of FIG. 8, the control component 810 handles tasks such as performing routing protocols, performing label-based forwarding protocols, control packet processing, etc., which frees the packet forwarding component 890 to forward received packets quickly. That is, received control packets (e.g., routing protocol packets and/or label-based forwarding protocol packets) are not fully processed on the packet forwarding component 890 itself, but are passed to the control component 810, thereby reducing the amount of work that the packet forwarding component 890 has to do and freeing it to process packets to be forwarded efficiently. Thus, the control component 810 is primarily responsible for running routing protocols and/or label-based forwarding protocols, maintaining the routing tables and/or label forwarding information, sending forwarding table updates to the packet forwarding component 890, and performing system management. The example control component 810 may handle routing protocol packets, provide a management interface, provide configuration management, perform accounting, and provide alarms. The processes 830, 840, 850, 860 and 870 may be modular, and may interact with the OS kernel 820. That is, nearly all of the control processes communicate directly with the OS kernel 820. Using modular software that cleanly separates processes from each other isolates problems of a given process so that such problems do not impact other processes that may be running. Additionally, using modular software facilitates easier scaling.

Still referring to FIG. 8, the example OS kernel 820 may incorporate an application programming interface (“API”) system for external program calls and scripting capabilities. The control component 810 may be based on an Intel PCI platform running the OS from flash memory, with an alternate copy stored on the router's hard disk. The OS kernel 820 is layered on the Intel PCI platform and establishes communication between the Intel PCI platform and processes of the control component 810. The OS kernel 820 also ensures that the forwarding tables 896 in use by the packet forwarding component 890 are in sync with those 880 in the control component 810. Thus, in addition to providing the underlying infrastructure to control component 810 software processes, the OS kernel 820 also provides a link between the control component 810 and the packet forwarding component 890.

Referring to the routing protocol process(es) 830 of FIG. 8, this process(es) 830 provides routing and routing control functions within the platform. In this example, the RIP 831, ISIS 832, OSPF 833 and EIGRP 834 (and BGP 835) protocols are provided. Naturally, other routing protocols may be provided in addition, or alternatively. Similarly, the label-based forwarding protocol process(es) 840 provides label forwarding and label control functions. In this example, the LDP 836, RSVP 837, EVPN 838 and L2VPN 839 (and BGP 835) protocols are provided. Naturally, other label-based forwarding protocols (e.g., MPLS, SR, etc.) may be provided in addition, or alternatively. In the example router 800, the routing table(s) 839 is produced by the routing protocol process(es) 830, while the label forwarding information 845 is produced by the label-based forwarding protocol process(es) 840.

Still referring to FIG. 8, the interface process(es) 850 performs configuration of the physical interfaces and encapsulation.

The example control component 810 may provide several ways to manage the router. For example, it 810 may provide a user interface process(es) 860 which allows a system operator 865 to interact with the system through configuration, modifications, and monitoring. The SNMP 885 allows SNMP-capable systems to communicate with the router platform. This also allows the platform to provide necessary SNMP information to external agents. For example, the SNMP 885 may permit management of the system from a network management station running software, such as Hewlett-Packard's Network Node Manager (“HP-NNM”), through a framework, such as Hewlett-Packard's OpenView. Accounting of packets (generally referred to as traffic statistics) may be performed by the control component 810, thereby avoiding slowing traffic forwarding by the packet forwarding component 890.

Although not shown, the example router 800 may provide for out-of-band management, RS-232 DB9 ports for serial console and remote management access, and tertiary storage using a removable PC card. Further, although not shown, a craft interface positioned on the front of the chassis provides an external view into the internal workings of the router. It can be used as a troubleshooting tool, a monitoring tool, or both. The craft interface may include LED indicators, alarm indicators, control component ports, and/or a display screen. Finally, the craft interface may provide interaction with a command line interface (“CLI”) 860 via a console port, an auxiliary port, and/or a management Ethernet port.

The packet forwarding component 890 is responsible for properly outputting received packets as quickly as possible. If there is no entry in the forwarding table for a given destination or a given label and the packet forwarding component 890 cannot perform forwarding by itself, it 890 may send the packets bound for that unknown destination off to the control component 810 for processing. The example packet forwarding component 890 is designed to perform Layer 2 and Layer 3 switching, route lookups, and rapid packet forwarding.

As shown in FIG. 8, the example packet forwarding component 890 has an embedded microkernel 892 over hardware components 891, interface process(es) 893, ASIC drivers 894, and chassis process(es) 895, and stores a forwarding (e.g., route-based and/or label-based) table(s) 896. The microkernel 892 interacts with the interface process(es) 893 and the chassis process(es) 895 to monitor and control these functions. The interface process(es) 892 has direct communication with the OS kernel 820 of the control component 810. This communication includes forwarding exception packets and control packets to the control component 810, receiving packets to be forwarded, receiving forwarding table updates, providing information about the health of the packet forwarding component 890 to the control component 810, and permitting configuration of the interfaces from the user interface (e.g., CLI) process(es) 860 of the control component 810. The stored forwarding table(s) 896 is static until a new one is received from the control component 810. The interface process(es) 893 uses the forwarding table(s) 896 to look up next-hop information. The interface process(es) 893 also has direct communication with the distributed ASICs. Finally, the chassis process(es) 895 may communicate directly with the microkernel 892 and with the ASIC drivers 894.

Although example embodiments consistent with the present description may be implemented on the example routers of FIGS. 7 and 8, embodiments consistent with the present description may be implemented on communications network nodes (e.g., routers, switches, etc.) having different architectures. More generally, embodiments consistent with the present description may be implemented on an example system 900 as illustrated on FIG. 9.

FIG. 9 is a block diagram of an exemplary machine 900 that may perform one or more of the processes described, and/or store information used and/or generated by such processes. The exemplary machine 900 includes one or more processors 910, one or more input/output interface units 930, one or more storage devices 920, and one or more system buses and/or networks 940 for facilitating the communication of information among the coupled elements. One or more input devices 932 and one or more output devices 934 may be coupled with the one or more input/output interfaces 930. The one or more processors 910 may execute machine-executable instructions (e.g., C or C++ running on the Linux operating system widely available from a number of vendors) to perform one or more aspects of the present description. At least a portion of the machine executable instructions may be stored (temporarily or more permanently) on the one or more storage devices 920 and/or may be received from an external source via one or more input interface units 930. The machine executable instructions may be stored as various software modules, each module performing one or more operations. Functional software modules are examples of components of the present description.

In some embodiments consistent with the present description, the processors 910 may be one or more microprocessors and/or ASICs. The bus 940 may include a system bus and/or data links. The storage devices 920 may include system memory, such as read only memory (ROM) and/or random access memory (RAM). The storage devices 920 may also include a hard disk drive for reading from and writing to a hard disk, a magnetic disk drive for reading from or writing to a (e.g., removable) magnetic disk, an optical disk drive for reading from or writing to a removable (magneto-) optical disk such as a compact disk or other (magneto-) optical media, or solid-state non-volatile storage.

Some example embodiments consistent with the present description may also be provided as a machine-readable medium for storing the machine-executable instructions. The machine-readable medium may be non-transitory and may include, but is not limited to, flash memory, optical disks, CD-ROMs, DVD ROMs, RAMs, EPROMs, EEPROMs, magnetic or optical cards or any other type of machine-readable media suitable for storing electronic instructions. For example, example embodiments consistent with the present description may be downloaded as a computer program which may be transferred from a remote computer (e.g., a server) to a requesting computer (e.g., a client) by way of a communication link (e.g., a modem or network connection) and stored on a non-transitory storage medium. The machine-readable medium may also be referred to as a processor-readable medium.

Example embodiments consistent with the present description (or components or modules thereof) might be implemented in hardware, such as one or more field programmable gate arrays (“FPGA”s), one or more integrated circuits such as ASICs, one or more network processors, etc. Alternatively, or in addition, embodiments consistent with the present description (or components or modules thereof) might be implemented as stored program instructions executed by a processor. Such hardware and/or software might be provided in an addressed data (e.g., packet, cell, etc.) forwarding device (e.g., a switch, a router, etc.), or any device that has computing and/or networking capabilities.

### § 4.4 Refinements, Alternatives, and Extensions

### § 4.4.1 Data Structure for Signaling Preference Value

The procedures may be used to select only a subset of (e.g., preferred) egress PEs on an All-Active MHES for traffic forwarding until they all become unusable (e.g., unusable due to the attachment circuit to the MHES going down such as when the PEs go down, etc.). As already discussed above, each PE on an MHES may be provisioned with a preference value. The preference value may be the same as, or different from, the DF Preference (Recall, e.g., the document titled, “Preference-based EVPN DF Election”.). However, from an operational perspective, it may be advantageous to use the same value.

FIG. 10 is an example data structure 1000 for carrying a PE preference value for a given MHES in a manner consistent with some example implementations of the present application. It includes a type field 1010, a sub-type field 1020, a first reserved field 1030, a Designated Forwarder (DF) selection algorithm field 1040, a bitmap field 1050a/1050b, a second reserved field 1060, and a DF preference value field 1070. Each PE on the MHES should attach the DF Election Extended Community 1000 (or some other indication of preference) to its Ethernet Auto-Discovery (Type 1) per ES route. The DF Algorithm field 1040 is set to a value indicating either the Highest-Preference or Lowest-Preference algorithm (Recall, e.g., the document titled, “Preference-based EVPN DF Election”.). The Bitmap field 1050a/1050b is set to 0.

When performing the aliasing procedure per Section 14.1.2 “All-Active Redundancy Mode” in RFC 7432, an ingress PE should only consider usable Ethernet Auto-Discovery per ES routes with the highest or lowest preference values (depending on the signaled DF Algorithm 1040) in the DF Election Extended Community 1000. The routes for the other, non-preferred, MHES PEs may be used to build a backup path for fast switch over (e.g., FRR).

If an Ethernet Auto-Discovery per ES route is received, withdrawn, becomes unusable or usable such that the highest or lowest preference value changes, the aliasing procedure is performed again and the ingress PE updates its forwarding information, if necessary. Note that, if an Ethernet Auto-Discovery per ES route becomes usable and preferred over currently used ones, a local policy may be used to prevent immediate/automatic “revertive” behavior and the aliasing procedure can be performed based on timer or operator control.

### § 4.4.2 Alternative Ways to Group a Set of Preferred PEs in a Given MHES

In the example embodiment(s) described above, appropriately assigning preference values to egress PEs on a MHES and advertising them to an ingress PE allows the ingress PE to define (1) a set of one or more preferred PE(s), over which traffic will be load balanced if any of the preferred PE(s) is usable, and (2) one or more non-preferred PE(s), over which traffic will be load balanced if all of the preferred PE(s) are unusable. However, this is just one way to define a set of preferred PEs and non-preferred PEs. Alternative ways to define a set of preferred PEs (for a given MHES) and non-preferred PEs (for the give MHES) are described in §§ 4.3.2.1 and 4.3.2.2 below. Each case uses the concept of a cluster ESI (e.g., ESI X′) including two or more ESIs (e.g., ESI x and ESI y), as illustrated in FIG. 11.

### § 4.4.2.1 Alternative Using Cluster ID and Member ESIs

In one alternative implementation, the MHES is associated with a cluster ESI including (1) an ESI including the PE(s) within the preferred set, and (2) at least one ESI including PE(s) not within the preferred set. For example, to group the two different ESIs into a cluster, some example implementations may (1) configure a cluster-ESI, in addition to sub-cluster ESIs (e.g., esi-X and esi-Y), on the interfaces, and (2) advertise the cluster-ESI as an extended community in the Type-1 route.

### § 4.4.2.2 Alternative Using Implicit ESIs

In another alternative implementation, the MHES is associated with both (1) a first ESI including information indicating that the first ESI is of a type cluster ESI and further information identifying the first ESI, and (2) a second ESI including the information indicating that the second ESI is of a type cluster ESI and further information identifying the second ESI. This alternative implementation uses a paradigm of cluster-ESI as one of the existing reserved ESI types. With this, one type of reserved-ESI will be used. In one example, one part of the ESI (e.g., the first octet of the ESI) will be of the type Cluster-ESI, and another part of the ESI (e.g., the second octet of the ESI) will be the cluster-ID value. The rest of the ESI (e.g., the remainder of the octets) will be the different ESIs that are to be grouped (e.g., ESI x and ESI y).

### § 4.5 Examples of Operations of Example Methods

### § 4.5.1 Example of Operation of First Example Method

Referring to FIG. 12A, assume that a lower extended community preference value is preferred over a higher extended community preference value. As shown, double-dot dashed lines, the Type 1 advertisements from PE1 and PE2, for ESI X′, have extended community preference values of 10, while the Type 2 advertisements from PE3 and PE4 for ESI X′, have extended community preference values of 20. Therefore, for traffic to devices on ESI X′, PE1 and PE2 are preferred over PE3 and PE4. Referring to FIG. 12B, this preference is reflected in the forwarding table entry at ingress PE5 for destination CE1, in which the next hop (NH) is load balanced across PE1 and PE2 (assuming PE1 and PE2 are usable)(See the line and dashed line in FIG. 12B.), while a fast reroute (FRR) NH is load balanced across PE3 and PE4 (assuming that both PE1 and PE2 are unusable)(See the dotted and dot-dashed lines in FIG. 12C.) Note that if only one of PE1 and PE2 is usable, the ingress PE5 will forward traffic destined for CE1 to one of PE1 and PE2 that is usable.

Although a lower preference value is preferred over a higher preference value in the above example, the opposite may be true. That is, in some implementations, a higher preference value may be preferred over a lower preference value. In another example, in which a higher preference value is preferred, assume that PE1 has a preference value of 100, PE2 has a preference value of 200, and PE3 has a preference value of 300 and PE4 has a preference value of 300. This information will be advertised to PE5 and PE5 will have a forwarding entry for CE1 in which traffic is load balanced across PE3 and PE4 (each having a preference value of 300, which is the highest), with a FRR NH of PE2 (having a preference value of 200, which is the next highest). Thus, if the routes for PE3 and PE4 are withdrawn or no longer usable, the traffic to CE1 will be sent via PE 2. Assume that new PE9, PE10 and PE11 (not shown) are added to the ESI X′, and that they each have a preference value of 800. When ingress PE5 learns of this (e.g., when it receives a new Type 1 advertisement(s)), its forwarding table entry for destination CE1 will be updated so that PE9, PE10 and PE11 are the next hop (over which traffic is to be load balanced), and PE3 and PE4 become the FRR NH.

### § 4.5.2 Example of Operation of First Alternative Method (Using Cluster ID and MEMBER ESIs)

FIGS. 13A-13C illustrate a simple example in which a cluster ID and (cluster) member ESIs are used. Referring to FIG. 13A, PE1 and PE2 are configured with (1) ESI X on access interfaces, and (2) Cluster-ID-1. Their Type 1 advertisements to ingress PE5 indicate ESI X and extended community cluster ID=1, as shown by light double dot dashed lines. Similarly, PE3 and PE4 are configured with (1) ESI Y on access interfaces, and (2) the same cluster ID of Cluster-ID-1, as shown by heavy double dot dashed lines. Therefore, their Type 1 advertisements to ingress PE5 indicated ESI Y and extended community for cluster ID=1. The respective ESI extended Cluster Community will also carry a flag indicating whether the ESI (that is ESI x or ESI y) is primary or backup with respect to Cluster-ID-1.

Referring to FIG. 13B, ingress PE5 will process these Type-1 avertisements per ESI and realize that the extended-community of Cluster-ID is present. Consequently, the ingress PE5 will build the desired NH and FRR NH such that traffic to CE1 is load balanced across PE1 and PE2 when both are usable, as indicated by solid and dashed lines. In the event that both PE1 and PE2 are unusable, then traffic to CE1 is load balanced across PE3 and PE4 as shown by the dotted and dot-dashed lines in FIG. 13C. Note that only one of PE1 and PE2 is usable, then traffic to CE1 will be send via that usable one of PE1 and PE2.

### § 4.5.3 Example of Operation of Second Alternative Method (Using Implicit ESIs)

FIGS. 14A-14C illustrate a simple example in which a cluster ID and (cluster)member ESIs are used. Referring to FIG. 14A, assume that PE1 and PE2 are configured with the following ESI value:
08:05:11:11:11:11:11:11:11:11
   and that PE3 and PE4 are configured with the following ESI value:
08:05:22:22:22:22:22:22:22:22
   Each of PE1-PE4 advertise their respective ESI value (e.g., in a Type 1 advertisement), as shown by the light and heavy double dot-dashed lines in FIG. 14A.

Referring to FIG. 14B, when ingress PE5 receives the Type-1 advertisements, it will be able to deduce that Clustering is ON (as the first octet “08” suggests clustering), and that the two ESIs 08:05:11:11:11:11:11:11:11:11 and 08:05:22:22:22:22:22:22:22:22 are to be clustered (since the second octet “05” in each is the same). Assume that the ESI with lower value in the 3rd octet will be treated as primary. Therefore ESI 08:05:11:11:11:11:11:11:11:11 is treated as the primary ESI of the cluster, and ESI 08:05:22:22:22:22:22:22:22:22 is treated as the backup ESI of the cluster. Referring to FIG. 14B, the primary NH for destination CE1 includes PE1 and PE2 (load balanced), and the FRR NH for destination CE1 includes PE3 and PE4 (load balanced). In normal operation, ingress PE5 load balances traffic for CE1 across PE1 and PE2, as indicated by solid and dashed lines in FIG. 14B. Referring to FIG. 14C, if both PE1 and PE2 are DOWN, ingress PE5 load balances traffic for CE1 across PE3 and PE4, as indicated by the dotted and dot-dashed lines.

Note that in this second alternative implementation, code changes in interim devices are not needed. Also, no separate Cluster-ESI configuration is required because the ESI values themselves (08:05: . . . ) implicitly suggest clustering.

### § 4.5.4 Bum Handling in Alternatives

Referring to FIGS. 13A and 14A, since different ESIs are configured on PE1,PE2 (assume these PEs are at Site-A) and PE3,PE4 (assume that these PEs are at Site-B), each ESI (and in this case, each site), will elect a destinated forwarder (DF) for itself, per RFC 7432. Consequently, when ingress PE5 sends BUM traffic to the elected DF at each site (i.e., the elected DF on each ESI). This will result in BUM traffic duplication from CE2 to CE1, which is undesired. To prevent this unwanted duplication of BUM traffic, the backup site (Site-B including PE3 and PE4) remains backup for the Cluster ESIs, unless all the PEs in the primary site (Site-A including PE1 and PE2) are unusable.

Per RFC 7432, each of PE3 and PE4 computes its DF based on Type 4 route types (RTs) received from its own multihomed peers (on the same MHES). To avoid the unwanted duplication of BUM traffic discussed above, in the alternative implementations, PE3 and PE4 will also check if DF calculation is done for a Cluster ESI, and if there is another ESI (e.g., the ESI associated with PE1 and PE2 at Site-A) acting as Primary Cluster for the Cluster ESI, then it will hold on to its DF election (that is, it won't reperform DF election). PE3 and PE4 will be aware of the other PEs (PE1 and PE2 at Site A) based on Type 1 route type (RT) advertisements received from PE1 and PE2 having ESI Cluster and primary/backup information.

Assume that PE1 is the DF. When PE1 goes DOWN, PE2 will becomes DF for Site-A and will continue to advertise Type 1 advertisements RT with Cluster Primary information, and PE3 and PE4 will hold on to their respective DF elections (that is, they won't reperform DF election). BUM traffic from CE2 will be delivered, via PE2, to CE1. If both PE1 and PE2 are DOWN, there will be no Type 1 advertisement RT with Primary Cluster Information. In this scenario, PE3 and PE4 will start their DF election and one will be elected as DF. The elected DF will forward BUM traffic from CE2 to CE1. Note that if either PE1 or PE2 then comes UP, one will be elected DF (perhaps after a delay or delay condition to permit synchronization of route information).

What is claimed is:

1. For use in an Ethernet Virtual Private Network (EVPN) having a plurality of provider edge devices (PEs) on a multihoming Ethernet Segment (MHES), a computer-implemented method for controlling aliasing behavior by an ingress PE on the EVPN, the computer-implemented method comprising:
a) configuring, on each of the plurality of PEs on the MHES, a preference value for the MHES, such that a set of one or more of the plurality of PEs each have a preference value higher (or lower) than the preference value of any of the plurality of PEs on the MHES not belonging to the set; and
b) advertising, by each of the plurality of PEs on the MHES, its preference value to the ingress PE.

2. The computer-implemented method of claim 1, wherein the advertisement is an EVPN Ethernet Auto-Discover per ES route.

3. The computer-implemented method of claim 2, wherein the preference value is encoded in the Designated Forwarder (DF) Election Extended Community.

4. The computer-implemented method of claim 1, further comprising:
c) receiving, by the ingress PE, the advertised preference values sourced from each of the plurality of PEs on the MHES; and
d) responsive to receiving the advertised preference values from each of the plurality of PEs on the MHES, generating forwarding table information including an aliasing next hop (NH) such the ingress PE will (A) load balance traffic for the MHES across any usable PEs within the set, or (B) load balance traffic for the MHES across at least one PE not within the set responsive to all of the PEs within the set being unusable.

5. The computer-implemented method of claim 4, wherein the PEs within the set are primary members of the aliasing NH, and PEs not within the set are backup members of the aliasing NH.

6. The computer-implemented method of claim 4, wherein the PEs not within the set are Fast ReRoute (FRR) NHs.

7. The computer-implemented method of claim 4, further comprising:
e) receiving, by the ingress PE, updated advertised preference values sourced from each of a plurality of PEs on the MHES; and
f) responsive to receiving the updated advertised preference values from each of the plurality of PEs on the MHES, rerunning an aliasing procedure.

8. The computer-implemented method of claim 1, wherein the MHES is associated with a cluster ESI including (1) an ESI including the PEs within the set, and (2) at least one ESI including PEs not within the set.

9. The computer-implemented method of claim 1, wherein the MHES is associated with both (1) a first ESI including information indicating that the first ESI is of a type cluster ESI and further information identifying the first ESI, and (2) a second ESI including the information indicating that the second ESI is of a type cluster ESI and further information identifying the second ESI.

10. A non-transitory computer-readable storage medium storing processor-executable instructions which, when executed by at least one processor, cause the at least one processor to perform a method comprising:
a) configuring, on each of the plurality of PEs on the MHES, a preference value for the MHES, such that a set of one or more of the plurality of PEs each have a preference value higher (or lower) than the preference value of any of the plurality of PEs on the MHES not belonging to the set; and
b) advertising, by each of the plurality of PEs on the MHES, its preference value to the ingress PE.

11. The non-transitory computer-readable storage medium of claim 10, wherein the advertisement is an EVPN Ethernet Auto Discover per ES route.

12. The non-transitory computer-readable storage medium of claim 10, wherein the preference value is encoded in the Designated Forwarder (DF) Election Extended Community.

13. A system for use in an Ethernet Virtual Private Network (EVPN) having a plurality of provider edge devices (PEs) on a multihoming Ethernet Segment (MHES) and an ingress PE on the EVPN, the system including the plurality of PEs, each of the plurality of PEs comprising:
a) at least one processor; and
b) at least one computer-readable storage system storing processor-executable instructions which, when executed by the at least one processor, cause the at least one processor to
1) configure on the PE on the MHES, a preference value for the MHES, such that a set of one or more of the plurality of PEs each have a preference value higher (or lower) than the preference value of any of the plurality of PEs on the MHES not belonging to the set; and
2) advertising, by each the PE on the MHES, its preference value to the ingress PE.

14. The system of claim 13, wherein the advertisement is an EVPN Ethernet Auto-Discover per ES route.

15. The system of claim 14, wherein the preference value is encoded in the Designated Forwarder (DF) Election Extended Community.

16. The system of claim 13, further comprising the ingress PE, the ingress PE comprising:
a) at least one processor; and
b) at least one computer-readable storage system storing processor-executable instructions which, when executed by the at least one processor of the ingress PE, cause the at least one processor of the ingress PE to
1) receive the advertised preference values sourced from each of the plurality of PEs on the MHES; and
2) responsive to receiving the advertised preference values from each of the plurality of PEs on the MHES, generate forwarding table information including an aliasing next hop (NH) such the ingress PE will (A) load balance traffic for the MHES across any usable PEs within the set, or (B) load balance traffic for the MHES across at least one PE not within the set responsive to all of the PEs within the set being unusable.

17. The system claim 16, wherein the PEs within the set are primary members of the aliasing NH, and PEs not within the set are backup members of the aliasing NH.

18. The system of claim 16, wherein the PEs not within the set are Fast ReRoute (FRR) NHs.

19. The system of claim 13, wherein the MHES is associated with a cluster ESI including (1) an ESI including the PEs within the set, and (2) at least one ESI including PEs not within the set.

20. The system of claim 13, wherein the MHES is associated with both (1) a first ESI including information indicating that the first ESI is of a type cluster ESI and further information identifying the first ESI, and (2) a second ESI including the information indicating that the second ESI is of a type cluster ESI and further information identifying the second ESI.
